(19) United States
(12) Patent Application Publication
(10) Pub. No.: US 2003/0201340 A1
(43) Pub. Date: Oct. 30, 2003

(54) Fluid sprayer with a motor-driven pump

(76) Inventor: John D. Hanson, San Diego, CA (US)

Correspondence Address: John D. Hanson, 2727 DeAnza Rd., K18, San Diego, CA, 92109, US

(21) Appl. No.: 10/431,672

(22) Filed: May 8, 2003

Related U.S. Application Data
(63) Continuation-in-part of application No. 10/098,061, filed on Mar. 15, 2002.

(51) Int. Cl. A62C 11/00

(52) U.S. Cl. 239/332; 239/331; 239/329

(57) ABSTRACT

An improved liquid sprayer having a container (12) with a handle (14). A supply tube (16) extends into the container (12) and upward through a container cap (18) and a container cap attachment (20) and into a pump inlet (22) which is open to a pump (24). Adjacent to the front of pump (24) is a pump outlet (26) and a nozzle (27). Adjacent to the rear of pump (24) is a pump drive (32) which removably communicates with a pump drive socket (34) affixed to a conventional rechargeable drill (36). The drill sprayer (10) can be removably attached to the container (12) which then is refilled and reused. Alternately, the drill sprayer (10) can be permanently affixed to the container (12) and therefore disposable.

### CROSS-REFERENCE TO RELATED APPLICATION

This application is a continuation-in-part of and claims priority on pending U.S. patent application Ser. No. 10/098,061, filed on Mar. 15, 2002, entitled “Drill Sprayer”, the contents of which are incorporated herein by reference.

### BACKGROUND

This invention relates to hand-held operated fluid dispensers, specifically to an improved fluid sprayer.

### BACKGROUND

Hand-held motorized fluid dispensers are known and are shown for example in U.S. Pat. No. 4,154,375 to Bippus, U.S. Pat. No. 5,150,841 to Silvenis et al., and U.S. Pat. No. 5,716,007 to Nottingham et al. In such prior dispensers, an electric motor is selectively connected to a battery source. When energized, the motor operates a pump mechanism by which fluid in a supply container associated with the dispenser is pumped through a discharge opening. Such prior dispensers have a number of disadvantages in that they are of low power, low torque, and have a short battery life. They therefore are of very limited output volume, spray velocity, distance of projection, and area of coverage. They have many elements and would be costly to manufacture and repair.

Additionally, prior art dispensers are complex. This complexity would render them inoperable without their own motor housing, pump and housing, and a container specific to the dispenser. A continuous spray stream is often not obtainable with these known systems. They would not be disposable due to the high cost of manufacture and therefore would not be tamperproof or childproof. Lastly, they often involve the mixing of hazardous chemicals and thus present potential liability.

### SUMMARY

In accordance with the present invention, a sprayer which dispenses fluids from a container using a motor-driven pump.

Accordingly, besides the objects and advantages of the fluid sprayer described above, several other objects and advantages are:

(a) to provide a sprayer which is permanently affixed to a container and disposable;

(b) to provide a sprayer which eliminates the mixing of hazardous chemicals because it is disposable;

(c) to provide a sprayer which is tamperproof and childproof;

(d) to provide a sprayer of high power, torque, and battery life;

(e) to provide a sprayer of high volume of spray and velocity of spray;

(f) to provide a sprayer with maximum distance of projection and area coverage;

(g) to provide a sprayer which sprays rapidly and efficiently, reducing time and labor;

(h) to provide a sprayer which produces a continuous stream of spray without pulsing;

(i) to provide a sprayer that is inexpensive to manufacture with a minimum of elements and of all plastic construction; and

(j) to provide a sprayer that dispenses fluid using any motor-driven force such as a conventional rechargeable drill.

Further objects and advantages will become apparent from the specification and drawings.

### BRIEF DESCRIPTION OF THE DRAWINGS

FIG. 1A is a side exploded plan view of a fluid sprayer having features of the present invention;

FIG. 1B is a side plan view of a fluid sprayer of FIG. 1A;

FIG. 1C is an alternative side plan view of a fluid sprayer of FIG. 1A;

FIG. 2 is a front exploded plan view of a portion of the fluid sprayer of FIG. 1A;

FIG. 3 is a rear exploded plan view of a portion of the fluid sprayer of FIG. 1A;

FIG. 4 is a partially exploded perspective view of a first embodiment of a sliding coupler having features of the present invention;

FIG. 5A is a partially exploded perspective view of a second embodiment of a sliding coupler having features of the present invention; and

FIG. 5B is a partially exploded perspective view of a third embodiment of a sliding coupler having features of the present invention.

### DESCRIPTION

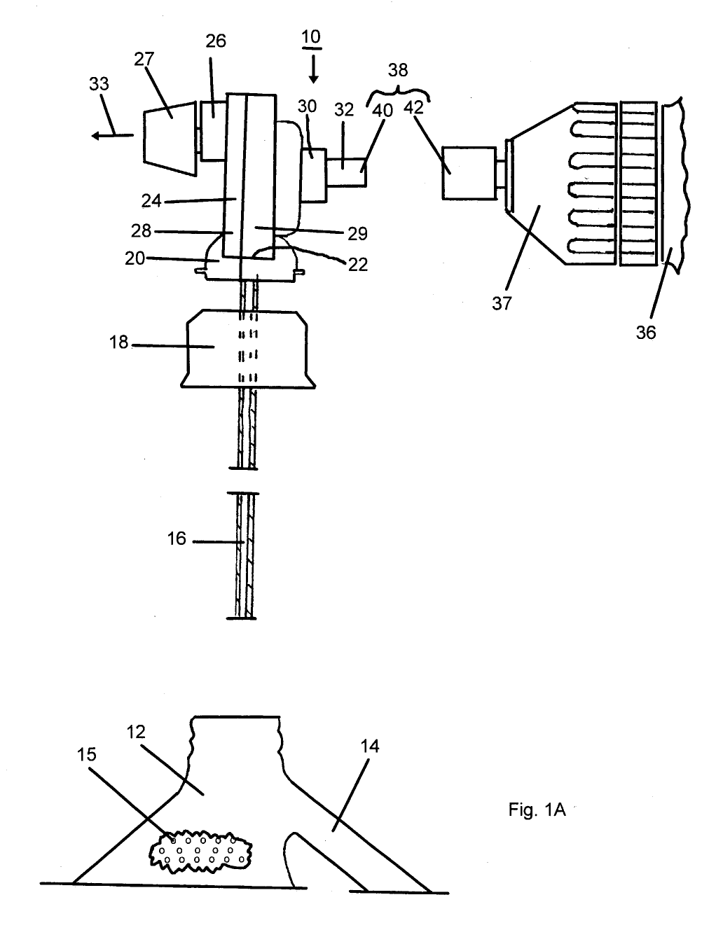

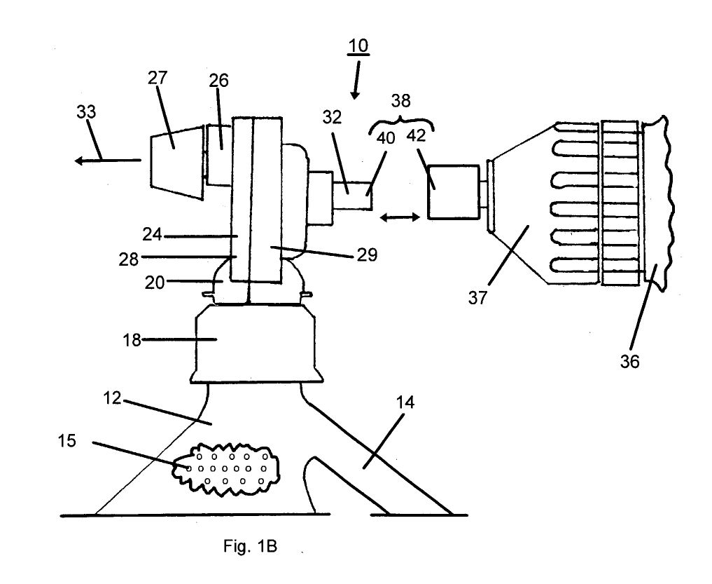

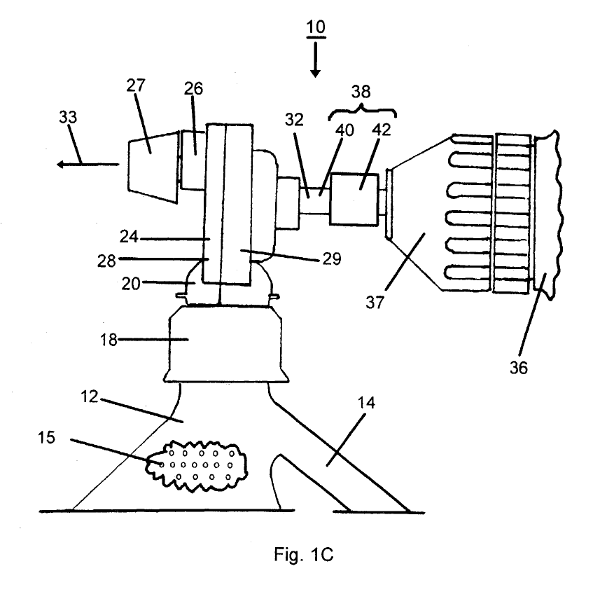

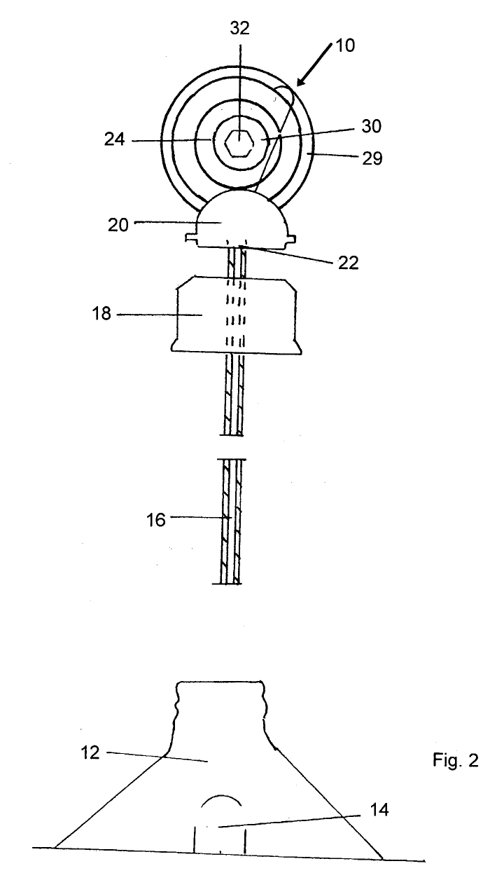

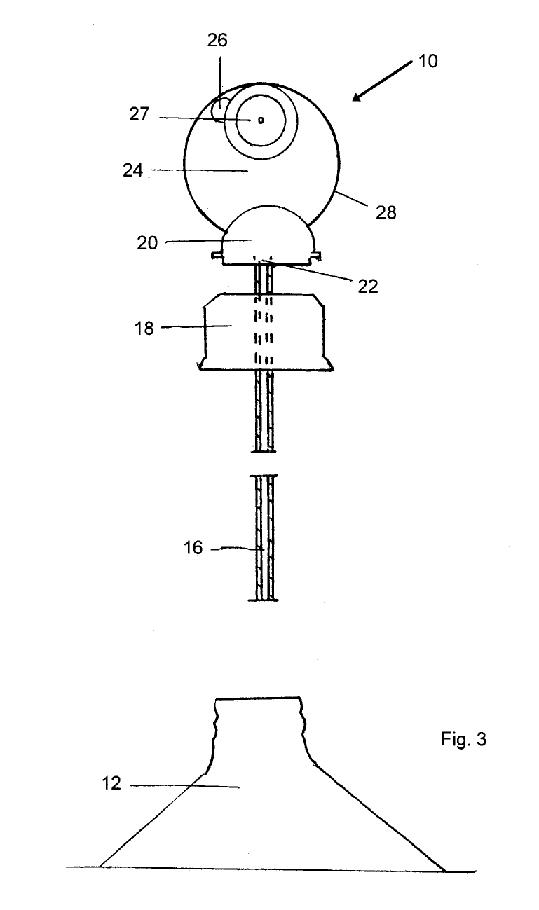

With reference now to the drawings, and in particular FIGS. 1A through 5B, a new fluid sprayer generally designated by the reference numeral 10 will be described.

The fluid sprayer designated a numeral 10 includes a container 12 (only partly shown in FIG. 1A) having a handle 14. The container 12 retains a fluid 15 (illustrated as circles in FIG. 1A). A supply tube 16 extends upward from container 12 through a container cap 18 and a container cap attachment 20. In one embodiment, the connection of container cap 18 and container cap attachment 20 allows 360 degree relative rotation between the container 12 and a pump 24. In one embodiment, the container cap 18 is permanently affixed to container 12. Alternatively, the container cap 18 may be removable attached to container 12 to allow refilling and reuse.

In one embodiment, atmospheric pressure equalization is provided by a vent diaphragm (not shown) in container cap 18 and is well known in current trigger sprayers. Supply tube 16 inserts into a pump inlet 22 which is open to pump 24. As shown in FIGS. 1A through 3, pump 24 is of centrifugal design. Other well known pump types could be employed including gear, piston, vane, diaphragm, or peristaltic. Of simple construction, the pump 24 consists of a front half-shell 28 including a pump outlet 26 and a nozzle 27; and a back half-shell including pump inlet 22, a pump seal 30, and a pump drive shaft 32. In the one embodiment, the front half-shell 28 and the back half-shell 29 are permanently bonded one to the other and the fluid sprayer 10 is of all plastic construction. The nozzle 27 directs a stream 33 (illustrated as an arrow in FIG. 1A) or spray of the fluid 15 at a target.

As further illustrated in FIGS. 1A-1C, the fluid sprayer 10 also includes a motor 36 (only partly shown in FIGS. 1A-1C) having a motor output 37 that drives pump 24. Motor 36 can be included within any conventional rechargeable drill that includes one or more batteries, a corded electric drill, or any other mechanism that provides motor output 37 in the form of a rotational force. In one embodiment, the motor output 37 includes a drill chuck.

FIGS. 1A-1C illustrate that the fluid sprayer 10 includes a sliding coupler 38 that provides the sole mechanical connection between the pump 24 and the motor 36. In one embodiment, the sliding coupler 38 includes a first coupler component 40 and a second coupler component 42 that cooperate to detachably couple the pump drive shaft 32 to the motor output 37. With this design, referring to FIGS. 1B and 1C, relative movement of pump 24 and motor 36 laterally causes the coupling (illustrated in FIG. 1C) and decoupling (illustrated in FIG. 1B) of the pump 24 and the motor 36. Stated another way, the pump 24 is secured to motor 36 with the sliding coupler 38 that includes the first coupler component 40 and the second coupler component 42 that cooperate to provide the sole mechanical coupling between pump 24 and motor 36.

The first coupler component 40 can be fixedly secured to motor output 37 and second coupler component 42 can be fixedly secured to the pump drive shaft 32. Alternatively, first coupler component 40 can be fixedly secured to the pump drive shaft 32 and second coupler component can be secured to the motor output 37. As examples, the first coupler component 40 can be integrally formed into the pump drive shaft 32 and/or the second coupler component 42 can be integrally formed into the motor output 37. In one embodiment, the second coupler component 42 includes an end that fits into and is retained by the drill chuck.

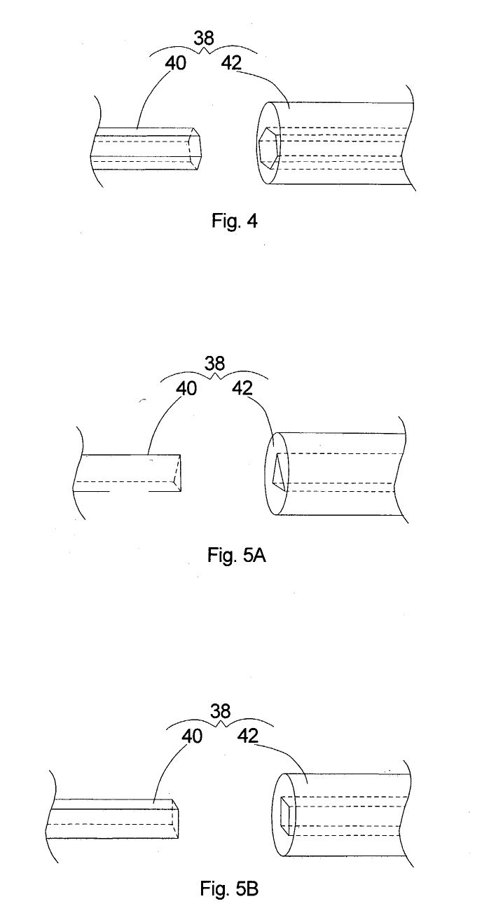

FIG. 4 illustrates a partially exploded perspective illustration of one embodiment of a sliding coupler 38 having features of the present invention. In this embodiment, the first coupler component 40 defines a projection and second coupler component defines a cavity that is sized and shaped to slidingly receive first coupler component 40. When first coupler component 40 is positioned within second coupler component 42, first coupler component 40 and second coupler component 42 cooperate to inhibit relative rotational movement between the coupler components 40, 42 during operation of the fluid sprayer 10.

The first coupler component 40 can be secured to pump drive shaft 32 or the motor output 37 and can be a projection having a cross-section that is substantially hexagon shaped. Additionally, the second coupler component 42 can be secured to motor output 37 or the pump drive shaft 32 and can have an outer circumference that has a substantially circular cross-section and an inner cavity that has a substantially hexagon shaped cross-section. The second coupler component 42 is sized and shaped so as to receive the first coupler component 40, thereby inhibiting relative rotational movement between second coupler component 42 and first coupler component 40. This in turn serves to inhibit relative rotational movement between pump 24 and motor 36. The hexagon shape of the cross-section of first coupler component 40 and the hexagon shape of the cross-section of the inner cavity of second coupler component 42 allow for selective coupling and uncoupling of rotational energy from motor 36 to pump 24 by simply sliding one of the coupler components 40, 42 relative to the other coupler component 42, 40.

FIGS. 5A and 5B illustrate alternative embodiments of sliding coupler 38, wherein the cross-section of first coupler component 40 and the cross-section of the cavity of second coupler component can be of different shapes sufficient to prevent relative rotational movement between pump 24 and motor 36. For example, as shown in FIG. 5A, first coupler component 40 can have a cross-section that is substantially triangle shaped and the inner cavity of second coupler component 42 can have a cross-section that is substantially triangle shaped. Further, as shown in FIG. 5B, first coupler component 40 can have a cross-section that is substantially rectangle shaped and the inner cavity of second coupler component 42 can have a cross-section that is substantially rectangle shaped.

The manner of using fluid sprayer 10 is to grasp container 12 by handle 14 with one hand, and to grasp motor 36 with the other hand. Motor 36 and pump 24 are then aligned to removably engage first coupler component 40 with second coupler component 42. Upon energizing motor 36, rotational energy is transmitted to pump 24 via sliding coupler 38 and a pressure differential of several bars is created. Low pressure is created at pump inlet 22 and suction draws fluid through supply tube 16 and into pump 24. High pressure is created at pump outlet 26 and fluid is forcefully sprayed through nozzle 27. Nozzle 27 is adjustable from a closed position, where no fluid can be sprayed through nozzle 27, through a spray position and to a stream position.

It should be noted that the design of the sliding coupler 38 allows the motor 36 to be quickly coupled and uncoupled from the pump 24 by simply moving the motor 36 laterally relative to the pump 24.

Alternative embodiments are possible with regard to fluid sprayer 10, motor 36, supply tube 16, container 12, and their positions relative to each other. One skilled in the art would see supply tube 16 could be of a length of several meters with fluid sprayer 10 affixed to one end and container 12 at the other. This embodiment gives the user great mobility and allows a large container 12 to be placed on the ground or any suitable surface negating lifting and carrying. Still alternatively, motor 36 could be attached removably to container 12 taking the function of handle 14. Supply tube 16 in this embodiment would be of adequate length and structure to be of the spraying wand configuration found on current hand-pump pressurized sprayers.

As to further discussion of the manner of usage and operation of the present fluid sprayer 10, the same should be apparent from the above description. Accordingly, no further discussion relating to the manner of usage and operation will be provided.

With respect to the above description then, it is to be realized that the optimum dimensional relationships for the parts of the fluid sprayer 10, to include variations in size, materials, shape, form, function and manner of operation, assembly and use, are deemed readily apparent and obvious to one skilled in the art, and all equivalent relationships to those illustrated in the drawings and described in the specification are intended to be encompassed herein.

Therefore, the foregoing is considered as illustrative only of the principles of the fluid sprayer 10. Further, since numerous modifications and changes will readily occur to those skilled in the art, it is not desired to limit the fluid sprayer 10 to the exact construction and operation shown and described, and accordingly, all suitable modifications and equivalents may be resorted to, falling within the scope of the invention.

1. A fluid sprayer for use with a fluid container that contains a fluid, the fluid sprayer comprising:
a pump that is secured to the fluid container, the pump having an inlet that is in fluid communication with the fluid container, and a pump drive shaft;
a motor that drives the pump, the motor having a motor output; and
a first coupler component and a second coupler component that cooperate to provide the sole mechanical coupling between the pump and the motor; wherein one of the coupler components is secured to the pump drive shaft and the other coupler component is secured to the motor output, wherein the first coupler component defines a projection and the second coupler component defines a cavity that is sized and shaped to slidingly receive the first coupler component while inhibiting relative rotation between the coupler components when the first coupler component is positioned in the second coupler component.

2. The fluid sprayer of claim 1 wherein the first coupler component is fixedly secured to the pump drive shaft and the second coupler component is fixedly secured to the motor output.

3. The fluid sprayer of claim 1 wherein the first coupler component is fixedly secured to the motor output and the second coupler component is fixedly secured to the pump drive shaft.

4. The fluid sprayer of claim 3 wherein the second coupler component is integrally formed into the pump drive shaft.

5. The fluid sprayer of claim 1 wherein a cross section of the cavity of the second coupler component and a cross section of the first coupler component are substantially hexagon shaped.

6. The fluid sprayer of claim 1 wherein a cross section of the cavity of the second coupler component and a cross section of the first coupler component are substantially rectangle shaped.

7. The fluid sprayer of claim 1 wherein a cross section of the cavity of the second coupler component and a cross section of the first coupler component are substantially triangle shaped.

8. The fluid sprayer of claim 1 wherein the motor is a rechargeable drill.

9. A combination including the fluid sprayer of claim 1 and a fluid container, the fluid container including a handle secured to a side of the fluid container for grasping so as to inhibit relative rotational movement between the fluid container and the motor.

10. The fluid sprayer of claim 1 further comprising a supply tube that connects the pump in fluid communication with the fluid container, wherein the pump withdraws the fluid from the fluid container through the supply tube.

11. The fluid sprayer of claim 10 further comprising a nozzle that is secured to the pump, the nozzle being adapted to discharge the fluid that is withdrawn from the fluid container through the supply tube.

12. A combination for spraying a fluid comprising:
a fluid container that contains a fluid, the fluid container including a handle secured to the side of the fluid container;
a pump that is secured to the fluid container, the pump having a pump drive shaft;
a supply tube that connects the pump in fluid communication with the fluid container, wherein the pump withdraws the fluid from the fluid container through the supply tube;
a nozzle that is secured to the pump, the nozzle being adapted to discharge the fluid that is withdrawn from the fluid container through the supply tube;
a motor that drives the pump, the motor having a motor output, wherein the handle is for grasping so as to inhibit relative rotational movement between the fluid container and the motor; and
a sliding coupler including a first coupler component and a second coupler component that cooperate to provide the sole mechanical coupling between the pump and the motor; wherein one of the coupler components is secured to the pump drive shaft and the other coupler component is secured to the motor output, wherein the first coupler component defines a projection and the second coupler component defines a cavity that is sized and shaped to slidingly receive the first coupler component while inhibiting relative rotation between the coupler components when the first coupler component is positioned in the second coupler component.

13. The combination of claim 12 wherein the first coupler component is fixedly secured to the pump drive shaft and the second coupler component is fixedly secured to the motor output.

14. The combination of claim 12 wherein the first coupler component is fixedly secured to the motor output and the second coupler component is fixedly secured to the pump drive shaft.

15. A fluid sprayer for use with a fluid container that contains a fluid, the fluid sprayer comprising:
a pump means that is secured to the fluid container, the pump means having an inlet means that is in fluid communication with the fluid container, and a pump drive means;
a motor means for driving the pump means, the motor means having a motor output means;
a sliding coupler means for providing the sole mechanical coupling between the pump means and the motor means, the sliding coupler means including a first coupler component and a second coupler component; wherein one of the coupler components is secured to the pump drive means and the other coupler component is secured to the motor output means, wherein the first coupler component defines a projection and the second coupler component defines a cavity that is sized and shaped to slidingly receive the first coupler component while inhibiting relative rotation between the coupler components when the first coupler component is positioned in the second coupler component.

16. The fluid sprayer of claim 15 wherein the first coupler component is fixedly secured to the pump drive means and the second coupler component is fixedly secured to the motor output means.

17. The fluid sprayer of claim 15 wherein the first coupler component is fixedly secured to the motor output means and the second coupler component is fixedly secured to the pump drive means.

18. The fluid sprayer of claim 15 wherein a cross section of the cavity of the second coupler component and a cross section of the first coupler component are substantially hexagon shaped.

19. The fluid sprayer of claim 15 further comprising a fluid supply means that connects the pump means in fluid communication with the fluid container, wherein the pump means withdraws the fluid from the fluid container through the fluid supply means.

20. The fluid sprayer of claim 19 further comprising a fluid output means for discharging the fluid that is withdrawn from the fluid container through the fluid supply means, the fluid output means being secured to the pump means.
